(19) United States
(12) Patent Application Publication
(10) Pub. No.: US 2016/0086736 A1
(43) Pub. Date: Mar. 24, 2016

(54) TANTALUM CAPACITOR

(71) Applicant: SAMSUNG ELECTRO-MECHANICS CO., LTD., Suwon-Si (KR)

(72) Inventors: Hong Kyu SHIN, Siheung-si (KR); Jae Bum CHO, Seoul (KR); Hyun Sub OH, Seoul (KR); Wan Suk YANG, Seoul (KR)

(21) Appl. No.: 14/821,406

(22) Filed: Aug. 7, 2015

(30) Foreign Application Priority Data
Sep. 23, 2014 (KR) 10-2014-0127218

(51) Int. Cl. H01G 9/052; H01G 9/042

(52) U.S. Cl. CPC H01G 9/0525; H01G 9/042

(57) ABSTRACT

The present invention relates to a tantalum capacitor which includes a plurality of tantalum sintered bodies placed side by side and formed by sintering tantalum powder, a plurality of cathode lead lines drawn out from a first side of each of the plurality of tantalum sintered bodies in the same direction, a molding part, a cathode terminal connected to the plurality of cathode lead lines and an anode terminal separated to the cathode terminal.

### CROSS REFERENCE(S) TO RELATED APPLICATIONS

This application claims the benefit under 35 U.S.C. Section [120, 119, 119(e)] of Korean Patent Application Serial No. 10-2014-0127218, entitled “TANTALUM CAPACITOR” filed on Sep. 23, 2014, which is hereby incorporated by reference in its entirety into this application.

### BACKGROUND OF THE INVENTION

1. Field of the Invention

The present invention relates to a tantalum capacitor; and, more particularly to a tantalum capacitor equipped with a plurality of tantalum sintered bodies.

2. Description of the Related Art

Tantalum (Ta) is widely used as a cathode material for a small size capacitor because of the characteristics to form a stable oxide film. A tantalum capacitor structure made from tantalum uses a small gap formed when hardening the sintered tantalum powder.

A general tantalum capacitor has no direction of DC-bias, and it is not affected by acoustic noise. An equivalent series inductance (ESL) in a tantalum capacitor refers to an inductance which parasites in the circuit, and reducing the ESL value of the tantalum capacitor is very important in designing powers of a printed circuit board (PCB).

However, due to release of high-valued electronic products such as smart phones, capacitors operating in a high frequency are on demand but general tantalum capacitors cannot satisfy this demand.

### SUMMARY OF THE INVENTION

The present invention has been invented in order to overcome the above-described problems and it is, therefore, an object of the present invention to provide a tantalum capacitor that can operate with low ESL in a high frequency band.

In accordance with an embodiment of the present invention to achieve the object, there is provided a tantalum capacitor including a plurality of tantalum sintered bodies placed side by side and formed by sintering tantalum powder, a plurality of cathode lead lines drawn out from a first side of each of the plurality of tantalum sintered bodies in the same direction, a molding part, a cathode terminal connected to the plurality of cathode lead lines and an anode terminal separated from the cathode terminal. At this time, the cathode terminal includes a first side cover unit connected to the plurality of cathode lead lines for covering the first side to be separated by the molding part and an external terminal unit for covering a portion of a top surface or a bottom surface of the plurality of tantalum sintered bodies to be separated by the molding part.

At this time, in accordance with one aspect of the present invention, the anode terminal includes an opposite side cover unit for covering an opposite surface to be electrically connected to the opposite surface of the first side and an external terminal unit for covering a portion of the top surface or the bottom surface to be separated by the molding part.

In one example, a conductive layer may be applied on an opposite surface of a plurality of tantalum sintered bodies. Also, the anode terminal may be electrically connected by a conductive adhesive layer formed on the opposite surface of the plurality of tantalum sintered bodies.

And also, in accordance with another aspect of the present invention, the anode terminal equips an opposite side cover unit which covers in a way that an opposite surface of a first side of each of the plurality of tantalum sintered bodies is separated by the molding part, an external terminal unit for covering a portion of the top surface or the bottom surface to be separated by the molding part and an anode connecting unit to be electrically connected to a bottom surface or a top surface of the plurality of tantalum sintered bodies at the opposite sides of the external terminal unit.

Here, in one embodiment, the conductive layer may be applied on the bottom or the top surface of the plurality of tantalum sintered bodies that are electrically connected by the anode connecting unit. Also, the anode connecting unit can electrically connect by a conductive adhesive layer formed on the bottom or the top surface of the plurality of tantalum sintered bodies.

Next, in accordance with another aspect of the present invention, the anode terminal equips an opposite side cover unit which covers an opposite surface of the first side of each of the plurality of tantalum sintered bodies to be separated by the molding part and an external terminal unit which covers a portion of an opposite surface of the first side of each of the plurality of tantalum sintered bodies and electrically connected to the top or the bottom surface of the plurality of tantalum sintered bodies.

Here, in one example, the conductive layer may be applied on the top surface or the bottom surface of the plurality of tantalum sintered bodies that is electrically connected by the external terminal unit of the anode terminal. Also, the external terminal unit of the anode terminal may be electrically connected by the conductive adhesive layer, formed on the top surface or the bottom surface of the plurality of tantalum sintered bodies.

Also, in the above-described aspects of the embodiments of the present invention, at least two of the plurality of cathode lead lines may be drawn out side by side from the first side of each of the plurality of tantalum sintered bodies in the same direction.

Also, a groove may be formed on a protruded front end of the external terminal unit of the cathode terminal.

And also, in another example, a minimum space between each external terminal unit of the cathode terminal and the anode terminal is 200 to 400 μm. Also, a total area of the external terminal unit of the cathode terminal and the anode terminal is 60 to 80% of the top or the bottom surface of the molding part.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic perspective view of a tantalum capacitor in accordance with a first aspect of an embodiment of the present invention;

FIGS. 2A to 2C are schematic cross-sectional views of the tantalum capacitor in accordance with the first aspect of the present invention;

FIG. 3 is a schematic side view of a tantalum capacitor in accordance with another embodiment of the present invention;

FIG. 4 is schematic perspective view of a tantalum capacitor in accordance with a second aspect of the embodiment of the present invention;

FIGS. 5A to 5C are schematic cross-sectional views of the tantalum capacitor in accordance with the second aspect of the embodiment of the present invention; and

FIGS. 6A to 6C are schematic cross-sectional views of the tantalum capacitor in accordance with a third aspect of the embodiment of the present invention;

### DETAILED DESCRIPTION OF THE PREFERABLE EMBODIMENTS

Hereinafter, embodiments of the present invention will be described in detail with reference to the accompanying drawings. The following embodiments are provided as examples to fully convey the spirit of the invention to those skilled in the art. Therefore, the present invention should not be construed as limited to the embodiments set forth herein and may be embodied in different forms. The same components are represented by the same reference numerals hereinafter throughout the specification.

In this specification, when an element is referred to as being “connected” or “coupled” to another element, it can be “directly” connected or coupled to the other element or connected or coupled to the other element with another element interposed therebetween, unless it is referred to as being “directly connected” or “directly coupled” to the other element.

Reference in the specification to “connect” or “connecting”, as well as other variations thereof, means that an element is directly connected to the other element or indirectly connected to the other element through another element. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For example, the dimensions of some of the elements in the figures may be exaggerated relative to other elements to help improve understanding of embodiments of the present invention. The same reference numerals in different figures denote the same elements.

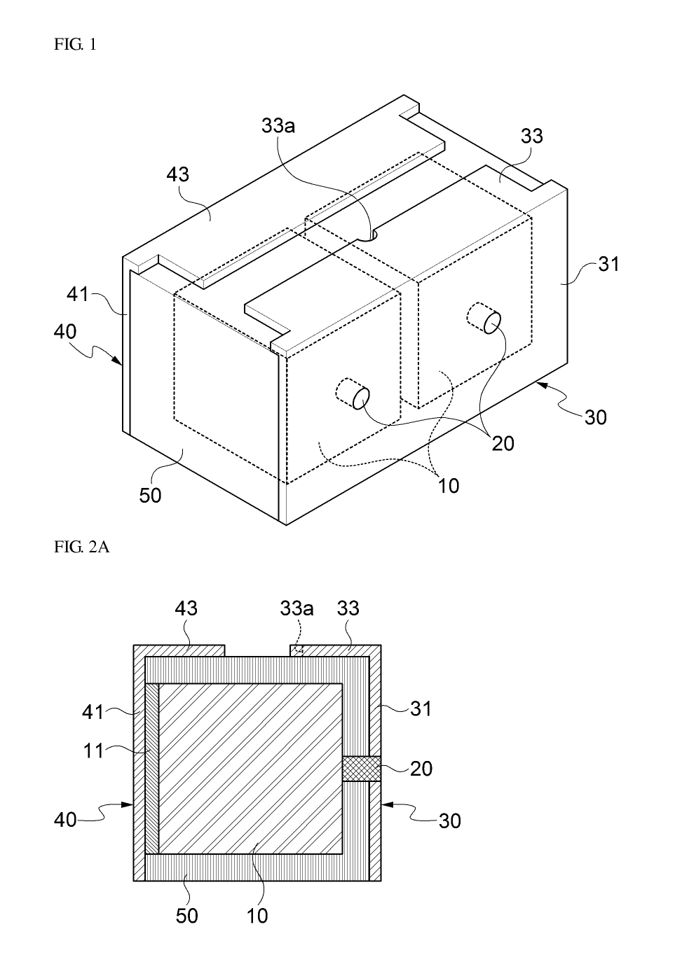

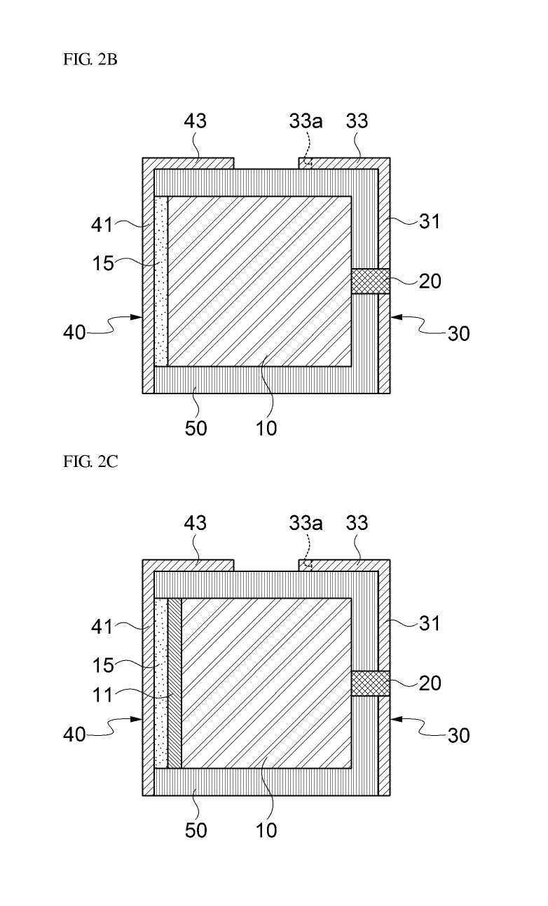

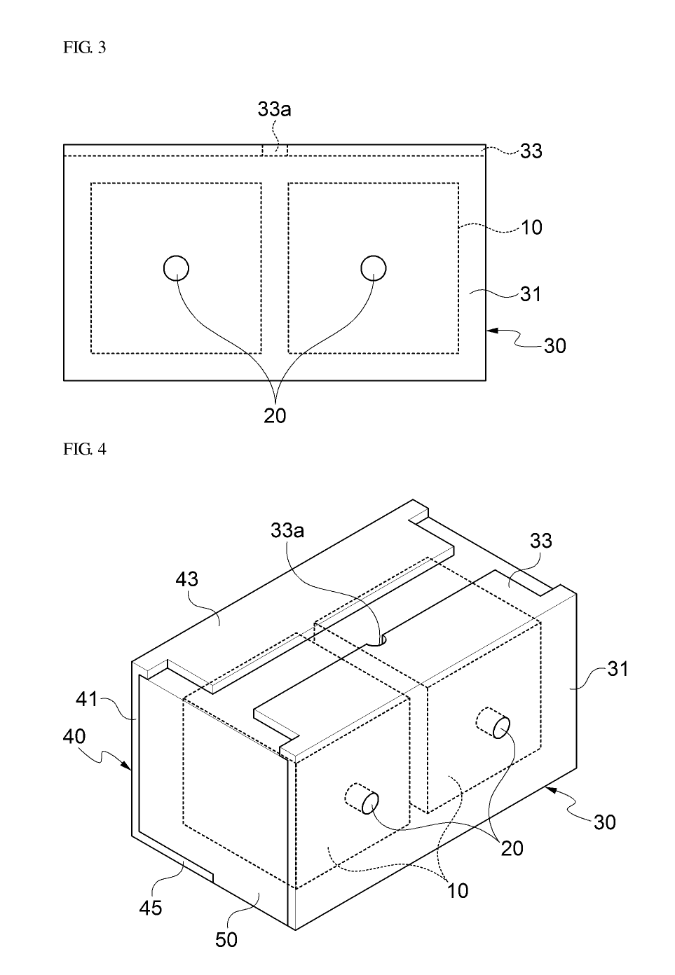

A tantalum capacitor in accordance with a first aspect of the present invention will be described with reference to FIGS. 1 to 3. Here, the reference numerals which are not shown in the referred drawings may be the reference numerals in the other drawings representing the same elements. FIG. 1 is a schematic perspective view of a tantalum capacitor in accordance with a first aspect of an embodiment of the present invention, FIGS. 2A to 2C are schematic cross-sectional views of the tantalum capacitor in accordance with the first aspect of the present invention and FIG. 3 is a schematic side view of a tantalum capacitor in accordance with another embodiment of the present invention.

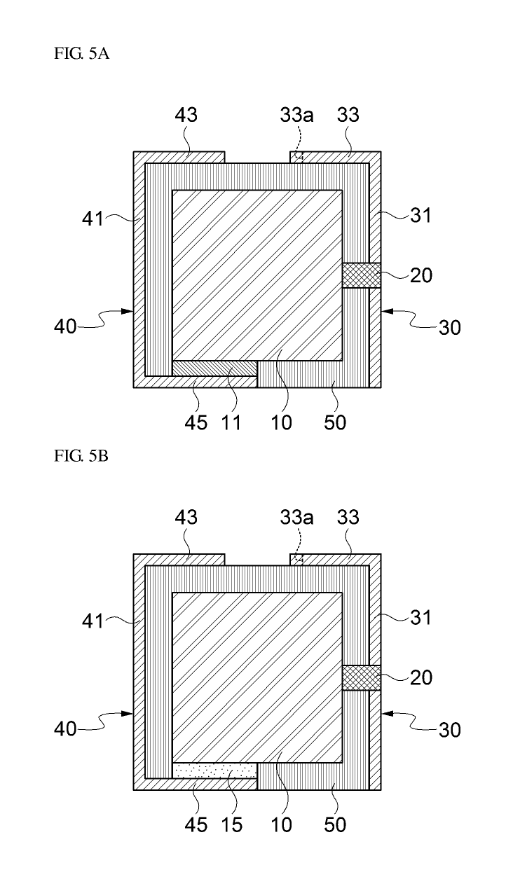

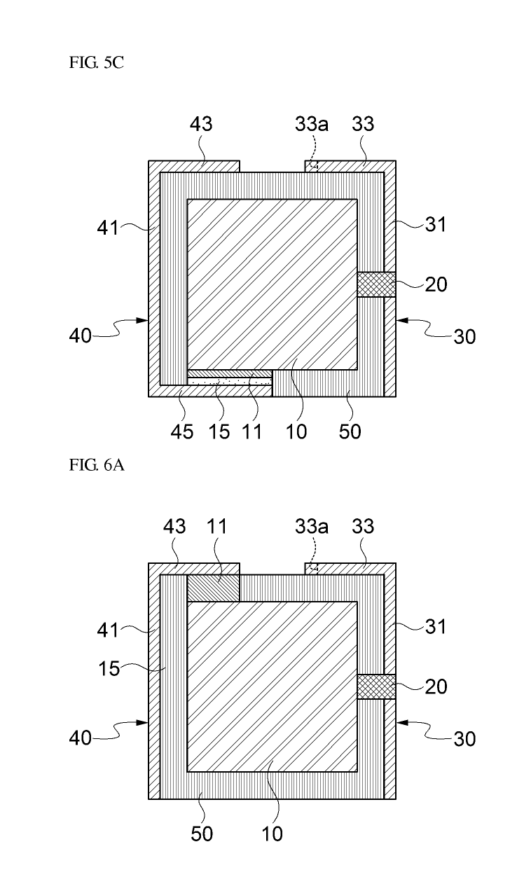

Next, a tantalum capacitor in accordance with a second aspect of the present invention is described with reference to FIGS. 4 to 5C. FIG. 4 is schematic perspective view of a tantalum capacitor in accordance with a second aspect of the embodiment of the present invention and FIGS. 5A to 5C are schematic cross-sectional views of the tantalum capacitor in accordance with the second aspect of the embodiment of the present invention.

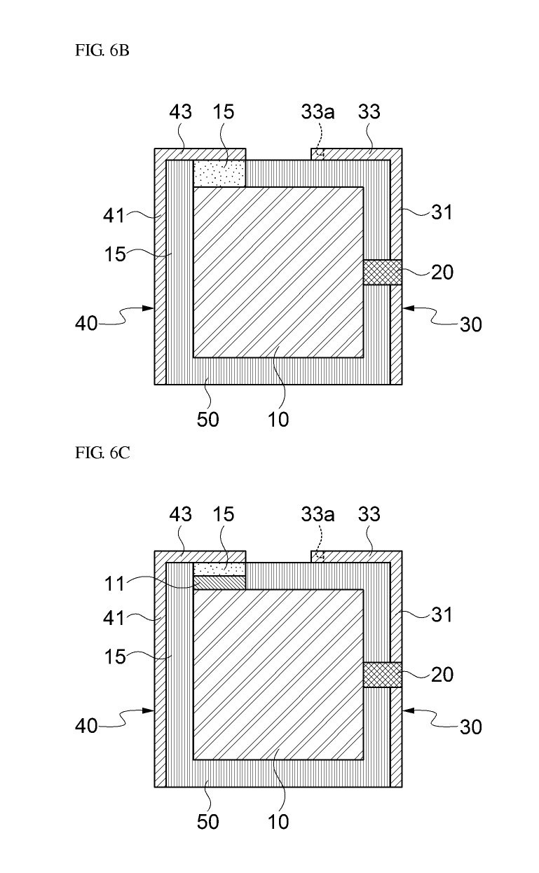

Next, a tantalum capacitor in accordance with a third aspect of the present invention is described with reference to FIGS. 6A to 6C. FIGS. 6A to 6C are schematic cross-sectional views of the tantalum capacitor in accordance with a third aspect of the embodiment of the present invention. At this time, the schematic perspective view of the tantalum capacitor shown in FIG. 1 may be also applied to the third aspect of the present invention.

### Description of Common Configurations Shown in Three Aspects of the Present Invention

A tantalum capacitor in accordance with the example of the present invention is formed by including a plurality of tantalum sintered bodies 10, a plurality of cathode lead lines 20, a molding part 50, a cathode terminal 30 and an anode terminal 40. Here, FIGS. 1 to 3 show the tantalum capacitor in accordance with a first aspect of the present invention, FIGS. 4 to 5C show the tantalum capacitor in accordance with the second aspect of the present invention and FIGS. 6A to 6C show the tantalum capacitor in accordance with a third aspect of the present invention.

Common configurations shown in the first to the third aspects of the present invention are described first, and a discriminative explanation of the first aspect is described as follows.

Referring to FIGS. 1 to 6C, the tantalum capacitor in accordance with an embodiment of the present invention is formed by including a plurality of tantalum sintered bodies 10, a plurality of cathode lead lines 20, a molding part 50, a cathode terminal 30 and an anode terminal 40. The plurality of tantalum sintered bodies 10, the plurality of cathode lead lines 20 and the cathode terminal 30 are commonly configured in embodiments of the first to the third aspects of the present invention. In each aspect, the molding part 50 commonly surrounds the plurality of tantalum sintered bodies 10 and the cathode lead line 20; however, the detailed portion being surrounded may differ. Also, in each aspect, there may be a difference in the structure of the anode terminal 40 or the combination structure.

Referring to FIGS. 1 to 6C, the plurality of tantalum sintered bodies 10 is arranged side by side and formed by sintering tantalum powder. For instance, the tantalum sintered body 10 can be made by stirring a mixture with a fixed ratio of tantalum powder and binder resin and the mixture is compressed to form a molding then sintered. For instance, the tantalum sintered body 10 can be made by inserting the cathode lead line 20 in a stirred powdered mixture added with binder resin and molded into a tantalum element of a desired size, then the tantalum element is sintered at 1000° C. to 2000° C. in a highly-vacuumed (below 10⁻⁵ torr) state for about 30 minutes. For instance, each tantalum sintered body 10 may be formed in a rectangular shape, but it is not limited thereto.

In an embodiment, on surfaces excluding at least a first side of the tantalum sintered body 10, a conductive layer 11 may be applied on the surface if needed. For instance, the conductive layer 11 may be applied on a surface that is electrically connected to the anode terminal 40. Here, the conductive layer 11 is to draw out anode electrodes. For instance, carbon or silver (Ag) may be applied as the conductive layer 11, but it is not limited thereto. Here, carbon reduces the contact resistance on the surface of the tantalum sintered body 10 and silver (Ag) draws out anode electrodes.

Also, in an embodiment, a conductive adhesive layer 15 may be formed on the surface of the tantalum sintered body 10 that is electrically connected to the anode terminal 40 to draw out anode electrodes. The conductive adhesive layer 15 may be formed directly on the surface of the tantalum sintered body 10 that is electrically connected to the anode terminal 40 or on the conductive layer 11 coated on the same surface. For instance, the conductive layer 15 may include epoxy resin or conductive metal powder, but it is not limited thereto.

Next, referring to FIGS. 1 to 6C, the plurality of cathode lead lines 20 is drawn out side by side from the first sides of each the plurality of tantalum sintered bodies 10 facing in the same direction. The cathode lead line 20 has a positive polarity. For instance, the cathode lead line 20 may be formed during the manufacturing process of the tantalum sintered body 10. Before compressing the stirred powder, the cathode lead line 20 is inserted on the first side of the molding and the molding combined with the cathode lead line 20 is then sintered. For instance, the cathode lead line 20 is inserted eccentrically with the center of the first side, for instance, installed on a position headed towards an external terminal unit of the cathode terminal 30. When the cathode lead line 20 is formed towards the external terminal unit of the cathode terminal 30 on the first side of each tantalum sintered body 10, ESL (Equivalent Series Inductance) of a tantalum capacitor may be additionally reduced due to a shorter current path.

For instance, the cathode lead line 20 may be a material of conductive metal. For instance, a wire with the same tantalum material as the tantalum sintered body may be used, but it is not limited thereto.

Although it is not shown, in an embodiment of the three forms of the present invention, more than two cathode lead lines 20 may be drawn out side by side from the first sides of each the plurality of tantalum sintered bodies 10 facing in the same direction. It is shown in FIGS. 1 to 6C that each tantalum sintered body 10 draws out one cathode lead line 20, however in the embodiment; and each tantalum sintered body 10 may draw out more than two cathode lead lines 20. When a plurality of cathode lead lines 20 is drawn out from the first side of each tantalum sintered body 10, a parallel structure of current paths may be formed in each tantalum sintered body 10 reducing an equivalent series resistance (ESR). Also, it effects in the reduction of ESL since the impedance is decreased by the parallel structure. Here, the cathode lead line 20 drawn out from by each tantalum sintered body 10 is formed towards not the center but the both side on the first side of each tantalum sintered body 10, an equivalent series inductance (ESL) of a tantalum capacitor may be additionally reduced due to a shorter current path.

Next, referring to FIGS. 1 to 6C, the molding part 50 surrounds the plurality of tantalum sintered bodies 10 and the plurality of cathode lead lines 20. For instance, the molding part 50 surrounds the rest excluding the connection area of the plurality of tantalum sintered bodies 10 and the anode terminal 40. Also, the molding part 50 surrounds the cathode lead line 20 to separate the cathode terminal 30 connected to the cathode lead line 20 from the tantalum sintered body 10. Here, the molding part 50 is formed in a way that a terminal of the cathode lead line 20 penetrates the molding to be exposed, the exposed cathode lead line 20 and the cathode terminal 30 is connected. The molding part 50 protects the tantalum sintered body 10 and the cathode lead line 20 from the external environment. Resin such as epoxy or Silica based an epoxy molding compound (EMC) may be used, but it is not limited thereto.

In an embodiment of the three forms of the present invention, there is a specific difference in the connection area of the tantalum sintered body 10 and the anode terminal 40, thus specific descriptions of the molding part 50 according to the three forms of the present invention are shown later in each embodiment of the invention.

Next, referring to FIGS. 1 to 6C, the cathode terminal 30 equips a first side cover unit 31 and an external terminal unit 33. For instance, the cathode terminal 30 may be formed by plating or sputtering at least one of the following material: Cr(Ti), Cu, Ni, Pd, or Au, but it is not limited thereto.

The first side cover unit 31 of the cathode terminal 30 covers the first side of the plurality of tantalum sintered bodies 10 to be separated by the molding part 50. Here, the first side cover unit 31 is connected with the plurality of cathode lead lines 20 which are exposed by penetrating the molding part 50. For instance, referring to FIGS. 1 to 6C, it is shown that the plurality of cathode lead lines 20 penetrates the first side cover unit 31 then connected. Although not shown, in an embodiment, the plurality of cathode lead lines 20 may be connected to the first side cover unit 31 without penetrating the first side cover unit 31.

The external terminal unit 33 of the cathode terminal 30 covers in a way that a top and a bottom surface of the plurality of tantalum sintered bodies 10 is separated by the molding part 50. The external terminal unit 33 of the cathode terminal 30 can be formed by extending the first side cover unit 31 and then bent to cover a part of a top surface or a bottom surface.

For instance, the external terminal unit 33 of the cathode terminal 30 may be used as a terminal to electrically connect with other electronic components. The external terminal unit 33 forms a mounting surface of a capacitor improving the volumetric efficiency of the tantalum sintered body 10 compared to a structure of prior art, which lead terminals are formed on a top and a bottom and withdrawn from both sides of the molding part 50 to form a terminal.

For instance, in an embodiment, an area of the external terminal unit 33 of the cathode terminal 30 may be formed to cover 30 to 40% of the top or the bottom surface of the molding part 50, but it is not limited thereto. If the area of the external terminal unit 33 of the cathode terminal 30 covering the top or the bottom surface of the molding part 50 is less than 30%, the mounting area, when mounting the tantalum capacitor, may be too small resulting in an increase in a defect rate of the product. On the other hand, if the area exceeds 40% of the top or the bottom surface area of the molding part 50, shortage failure may increase when mounting the tantalum capacitor on the product since the distance between the cathode terminal 30 and the anode terminal 40 is too short.

For instance, in an embodiment, a groove 33a may be formed on a front end of the external terminal unit 33 of the cathode terminal 30. The groove 33a shows the polarity.

Further on, referring to FIGS. 1 to 6C, the anode terminal 40 is separated from the cathode terminal 30. For instance, the anode terminal 40 may be formed by plating or sputtering at least one of the following material: Cr(Ti), Cu, Ni, Pd, or Au, but it is not limited thereto.

An external terminal unit 43 of the anode terminal 40 can be formed by extending an opposite side cover unit 41 and then bent to cover a top surface or a bottom surface of the molding part 50. Here, the opposite side cover unit 41 covers an opposite surface of the first side of the plurality of tantalum sintered bodies 10. The external terminal unit 43 of the anode terminal 40 is formed to separate from the external terminal unit 33 of the cathode terminal 30 with a predeterminate space in the top or the bottom surface of the molding part 50.

For instance, the external terminal unit 43 of the anode terminal 40 may be used as a terminal to electrically connect with other electronic components. For instance, the external terminal unit 43 of the anode terminal 40 is formed on the mounting surface of the tantalum capacitor improving the volumetric efficiency of the tantalum sintered body 10, compared to a structure of prior art which lead terminals are formed on a top and a bottom and withdrawn from both sides of the molding part 50 to form a terminal.

In an embodiment, an area of the external terminal unit 43 of the anode terminal 40 may be formed to cover 30 to 40% of the top or the bottom surface of the molding part 50, but it is not limited thereto. For instance, if the area of the external terminal unit 43 of the anode terminal 40 covering the top or the bottom surface of the molding part 50 is less than 30%, the mounting area, when mounting the tantalum capacitor, may be too small resulting in an increase in a defect rate of the product. On the other hand, if the area exceeds 40% of the top or the bottom surface area of the molding part 50, shortage failure may increase when mounting the tantalum capacitor on the product since the distance between the cathode terminal 30 and the anode terminal 40 is too short.

A structure or a combination structure of the anode terminal 40 may differ according to the three forms of the present invention, thus detailed descriptions of the anode terminal 40 are shown in each embodiment described later on.

Next, referring to FIGS. 1 to 6C, in an embodiment of each form of the present invention, a groove 33a may be formed on a protruded front end of the external terminal unit 33 of the cathode terminal 30. The groove 33a classifies the polarity of electrodes.

Also, referring to FIGS. 1 and/or 4, each external terminal unit 33 and 43 of the cathode terminal 30 and the anode terminal 40 can be formed in a protruded structure to face each other on the top or the bottom surface of the molding part 50. Here, FIG. 1 shows an embodiment of the first form of the present invention and FIG. 4 shows an embodiment of the second form of the present invention. Also, an embodiment of the third form of the present invention may be formed similar to a perspective view structure shown in FIG. 1.

Also, referring to FIGS. 2A to 2C, 5A to 5C, and 6A to 6C, in an embodiment of each forms of the present invention, the minimum space between each external terminal unit 33 and 43 of the cathode terminal 30 and the anode terminal 40 may be 200 to 400 μm. For instance, if the distance between the external terminal unit 33 of the cathode terminal 30 and the external terminal unit 43 of the anode terminal 40 is less than 200 μm, shortage failure may increase when mounting the tantalum capacitor on the product since the distance between the cathode terminal 30 and the anode terminal 40 is too short. However, if the distance exceeds 400 μm, the ESL value may increase.

Also, referring to FIGS. 1 and/or 4, in one of each form of the present invention, a total area of the external terminal unit 33 and 43 of the cathode terminal 30 and the anode terminal 40 may be 60 to 80% of the top or the bottom surface of the molding part 50. Here, FIG. 1 shows an embodiment of the first form of the present invention and FIG. 4 shows an embodiment of the second form of the present invention. Also, an embodiment of the third form of the present invention may be shown similar to FIG. 1. For instance, by forming the area of the external terminal unit 33 of the cathode terminal 30 to be 30 to 40% of the top or the bottom surface and the area of the external terminal unit 43 of the anode terminal 40 to be 30 to 40% on the top or the bottom surface of the molding part 50, the total area of the external terminal unit 33 and 43 of the cathode terminal 30 and the anode terminal 40 may be 60 to 80% of the top or the bottom surface area of the molding part 50.

According to the above described embodiments, by placing the plurality of tantalum sintered bodies 10 side by side and forming the first side cover unit 31 of the cathode terminal 30 and the opposite side cover unit 41 of the anode terminal 40 on each the first side area and the opposite side, forming the minimum space between each external terminal unit 33 and 43 of the cathode terminal 30 and the anode terminal 40 to be 200 to 400 μm and/or forming the total area of the external terminal unit 33 and 43 of the cathode terminal 30 and the anode terminal 40 to be 60 to 80% of the top or the bottom surface of the molding part 50, thus an electrode area may be significantly extended compared to a prior tantalum capacitor structure, therefore, the ESR and the ESL value of the capacitor may be additionally reduced.

### Detailed Descriptions of the Present Invention in Accordance with the First Aspect

In accordance with the first aspect of the present invention, there is a difference in the formation of the anode terminal 40 compared to the other forms.

In an embodiment of the first aspect of the present invention, the anode terminal 40 equips the opposite side cover unit 41 and the external terminal unit 43. Here, the opposite side cover unit 41 covers the opposite side of the first side of a plurality of tantalum sintered bodies 10 to electrically connect to the opposite surface of the first side. Here, the first side of the plurality of tantalum sintered bodies 10 is a side, which the plurality of cathode lead lines 20 is withdrawn side by side. In an embodiment, the opposite side cover unit 41 may be directly connected to the opposite of the first side of the plurality of tantalum sintered bodies 10, or through a conductive layer 11 as shown in FIG. 2A, or through a conductive adhesive layer 15 as shown in FIG. 2B, or through both of the conductive layer 11 and the conductive adhesive layer 15 as shown in FIG. 2C.

Also, the external terminal unit 43 of the anode terminal 40 covers in such a way that a top surface and a bottom surface of the plurality of tantalum sintered bodies 10 is separated by the molding part 50.

Referring to FIG. 2A, in an embodiment, the conductive layer 11 may be applied on the opposite surface of the first side of the plurality of tantalum sintered bodies 10. Here, the anode terminal 40 is electrically connected to the conductive layer 11. Here, Carbon or Silver (Ag) may be applied as the conductive layer 11, but it is not limited thereto. FIG. 2A only shows that the conductive layer 11 is applied to the opposite surface of the first side of the plurality of tantalum sintered bodies 10, however, for instance, surface except the first side of the tantalum sintered body 10 may be applied.

Also, referring to FIGS. 2B and 2C, in an embodiment, the anode terminal 40 may be electrically connected by the conductive adhesive layer 15 formed on the opposite surface of the first side of the plurality of tantalum sintered bodies 10. For instance, referring to FIG. 2B, the conductive adhesive layer 15 may be formed on the opposite surface of the first surface of the plurality of tantalum sintered bodies 10, and the anode terminal 40 may be connected to the conductive adhesive layer 15. Also, referring to FIG. 2C, the conductive layer 11 may be applied on the opposite surface of the first surface of the plurality of tantalum sintered bodies 10, the conductive adhesive layer 15 may be formed on the conductive layer 11, and the anode terminal 40 may be connected to the conductive adhesive layer 15. For instance, the conductive layer 15 may include epoxy resin or conductive metal powder, but it is not limited thereto.

Also, in an embodiment of the first form of the present invention, the electrically connection position with the anode terminal 40 is formed on the opposite surface of the first side of each tantalum sintered body 10, so there may be a difference in a detailed formation of the molding part 50 compared to the second and the third forms. Referring to FIGS. 1 to 2C, for instance, the molding part 50 may surround the rest surfaces excluding the opposite surface of the first side of the plurality of tantalum sintered bodies 10. For instance, when the conductive adhesive layer 15 is formed on a surface connected to the anode terminal 40 as shown in FIGS. 2B and/or 2C, unlike FIGS. 2B and/or 2C, the conductive adhesive layer 15 may be formed on a part of the connection surface and the rest regions may be covered by the molding part.

### Detailed Descriptions of the Present Invention in Accordance with the Second Form

The tantalum capacitor in accordance with the second aspect of the present invention, like stated above, is formed by including a plurality of tantalum sintered bodies 10, a plurality of cathode lead lines 20, a molding part 50, a cathode terminal 30 and an anode terminal 40. The following parts are commonly configured in embodiments of the first to the third form of the present invention, thus above descriptions are referred.

The molding part 50 may be similar to the embodiment described above in such a way that surrounds the plurality of tantalum sintered bodies 10 and the plurality of cathode lead lines 20. However, there is a partial difference when looked at it specifically referring to FIGS. 4 to 5C. Referring to FIGS. 4 to 5C in accordance with the second aspect of the present invention, for instance, the molding part 50 may surround the rest surfaces of the tantalum sintered bodies 10 except for the surface of the tantalum sintered body 10 connected an anode connecting unit 45 of the anode terminal 40. Also, the molding part 50 may cover the rest regions except connection position of the surface of tantalum sintered body 10 being connected to the anode connecting unit 45.

Next, referring to FIGS. 4 to 5C, the anode terminal 40 is separated from the cathode terminal 30, and equips the opposite side cover unit 41, the external terminal unit 43, and the anode connecting unit 45. The opposite side cover unit 41 of the anode terminal 40 covers in such a way that the opposite side of the first side of each the plurality of tantalum sintered bodies 10 is separated by the molding part 50. In an embodiment of the first form, the opposite side cover unit 41 is electrically connected to the opposite side of the first side of the plurality of tantalum sintered bodies 10, however in another embodiment of the second form, the opposite side cover unit 41 of the anode terminal 40 covers in a way that opposite side of the first side of each the plurality of tantalum sintered bodies 10 is separated by the molding part 50.

Also, an external terminal unit 43 of the anode terminal 40 covers in such a way that a portion of top surface or a bottom surface of the plurality of tantalum sintered bodies 10 is separated by the molding part 50.

Further on, the anode connecting unit 45 of the anode terminal 40 is electrically connected to the top surface or the bottom surface of the plurality of tantalum sintered bodies 10 on the opposite side of the external terminal unit 43. This additional formation of the anode connecting unit 45 distinguishes from the embodiment of the first form described above and the embodiment of the third form described later. Thus, in the embodiment of the first form described above, the function of the anode connecting unit 45 is performed by the opposite side cover unit 41, and in the embodiment of the third form described later, the function of the anode connecting unit 45 is performed by the external terminal unit 43 of the anode terminal 40. In an embodiment, the anode connecting unit 45 of the anode terminal 40 can be connected to the top or the bottom surface of tantalum sintered bodies 10 which is the opposite surface of the external terminal unit 43, or through a conductive layer 11 as shown in FIG. 5A, or through a conductive adhesive layer 15 as shown in FIG. 5B, or through both of the conductive layer 11 and the conductive adhesive layer 15 as shown in FIG. 5C.

Also, referring to FIG. 5A, in an embodiment, the conductive layer 11 may be applied on the top surface or the bottom surface of the plurality of tantalum sintered bodies 10 that is electrically connected though the anode connecting unit 45. FIG. 5A only shows that the conductive layer 11 is applied to the bottom surface of the plurality of tantalum sintered bodies 10, however, for instance, a surface except the first side of the tantalum sintered body 10 may be applied on.

Referring to FIGS. 5B and/or 5C, in an embodiment, the anode connecting unit 45 may be electrically connected by the conductive adhesive layer 15 formed on the top surface or the bottom surface of the plurality of tantalum sintered bodies 10. For instance, referring to FIG. 5B, the conductive adhesive layer 15 may be formed on the top surface or the bottom surface of the plurality of tantalum sintered bodies 10, and the anode connecting unit 45 may be connected to the conductive adhesive layer 15. Also, referring to FIG. 5C, the conductive layer 11 may be applied on the top or the bottom surface of the plurality of tantalum sintered bodies 10, the conductive adhesive layer 15 may be formed on the conductive layer 11, and the anode connecting unit may be connected to the conductive adhesive layer 15.

### Detailed Descriptions of the Present Invention in Accordance with the Third Aspect

The tantalum capacitor in accordance with the third aspect of the present invention, like stated above, is formed by including a plurality of tantalum sintered bodies 10, a plurality of cathode lead lines 20, a molding part 50, a cathode terminal 30 and an anode terminal 40. The following parts are commonly configured in embodiments of the first to the third form of the present invention, thus above descriptions are referred.

The molding part 50 may be similar to the embodiment described above in such a way that surrounds the plurality of tantalum sintered bodies 10 and the plurality of cathode lead lines 20. However, there is a partial difference when looked at it specifically referring to FIGS. 6A to 6C. Referring to FIGS. 6A to 6C in accordance with the third aspect of the present invention, for instance, the molding part 50 may surround the rest surfaces of the tantalum sintered bodies 10 except for the surface of the tantalum sintered body 10 connected an external terminal unit 43 of the anode terminal 40. Also, the molding part 50 may cover the rest regions except connected position in the surface, that is, the top surface or the bottom surface, of tantalum sintered body 10 being connected to the external terminal unit 43 of the anode terminal 40.

Next, referring to FIGS. 6A to 6C, the anode terminal 40 is separated from the cathode terminal 30, and equips the opposite side cover unit 41 and the external terminal unit 43. Here, the opposite side cover unit 41 covers in a way that an opposite side of a first side of each the plurality of tantalum sintered bodies 10 is separated by the molding part 50. In an embodiment of the first form, the opposite side cover unit 41 is electrically connected to the opposite side of the first side of each the plurality of tantalum sintered bodies 10, however in an embodiment of the third form, similar the embodiment of the second form described above, the opposite side cover unit 41 covers in such a way that opposite surface of the first side of each the plurality of tantalum sintered bodies 10 is separated by the molding part 50.

Also, it is identical to the embodiments of the first and the second aspects described above in a way that the external terminal unit 43 of the anode terminal 40 covers a part of the top surface or bottom surface of the plurality of tantalum sintered bodies 10. However, in the embodiment of the third form, the external terminal unit 43 of the anode terminal 40 is connected to the top or the bottom surface of the plurality of tantalum sintered bodies 10, which shows a difference in the external terminal unit 43 of the anode terminal 40 described in the embodiments of the first and the second forms. In an embodiment, the external terminal unit 43 of the anode terminal 40 can be directly connected to the top or the bottom surface of the plurality of tantalum sintered bodies 10, or through a conductive layer 11 as shown in FIG. 6A, or through a conductive adhesive layer 15 as shown in FIG. 6B, or through both of the conductive layer 11 and the conductive adhesive layer 15 as shown in FIG. 6C.

Also, referring to FIG. 6A, in an embodiment, the conductive layer 11 may be applied on the top or the bottom surface of the plurality of tantalum sintered bodies 10 that is electrically connected though the external terminal unit 43 of the anode terminal 40. FIG. 5A only shows that the conductive layer 11 is applied to the top surface of the plurality of tantalum sintered bodies 10, however, for instance, a surface except the first side of the tantalum sintered body 10 may be applied on.

Referring to FIGS. 6B and/or 6C, in an embodiment, the external terminal unit 43 of the anode terminal 40 may be electrically connected by the conductive adhesive layer 15 formed on the top or the bottom surface of the plurality of tantalum sintered bodies 10. For instance, referring to FIG. 6B, the conductive adhesive layer 15 may be formed on the top or the bottom surface of the plurality of tantalum sintered bodies 10, and the external terminal unit 43 of the anode terminal 40 may be connected to the conductive adhesive layer 15. Also, referring to FIG. 6C, the conductive layer 11 may be applied on the top or the bottom surface of the plurality of tantalum sintered bodies 10, the conductive adhesive layer 15 may be formed on the conductive layer 11, and the external terminal unit 43 of the anode terminal 40 may be connected to the conductive adhesive layer 15.

<ESL Reduction of the Capacitor in Accordance with an Embodiment of the Present Invention>

In the embodiments of the present invention, shortening the distance between electrodes and forming a plurality of parallel current paths reduce the ESL of the capacitor. Generally, it is advantageous to have many current paths that have a short distance between electrodes to reduce the ESL of the capacitor. In an embodiment of the present invention, by placing a plurality of tantalum sintered bodies 10 side by side and drawing out a cathode lead line 20 from each of the tantalum sintered bodies 10, then connecting to the cathode terminal 30, the ESL value is reduced due to a short distance between the electrodes, a wide area of the electrode terminals, and an increase in the number of current paths.

By placing the plurality of tantalum sintered bodies 10 side by side with electrodes formed not on the longer axis of the capacitor but on the shorter axis to shorten the distance between the terminals, and also connecting the plurality of tantalum sintered bodies 10 inside the tantalum capacitor in a parallel structure, the ESR of the capacitor is reduced resulting in a reduction in ESL. When drawing out side by side cathode lead lines 20 from each of the plurality of tantalum sintered bodies 10, the number of cathode lead lines 20 increased and the resistors inside the capacitor formed a parallel structure, thus affecting the impedance value controlling the ESL, reducing the ESL value. For instance, the ESR value of two tantalum sintered bodies 10 connected in parallel is theoretically half times the value of one tantalum sintered body 10, and this affects the impedance which controls the ESL so this functions to reduce the ESL value. Thus, minimizing the distance of electrodes and at the same time minimizing the internal resistance may reduce the ESL value.

Generally, the tantalum capacitor is affected by different characteristics near the resonance frequency. Here, in the transition from low frequency to the resonance frequency the tantalum capacitor is affected by the ESR, and in the transition from the resonance frequency to high frequency (for example, 1 to 6 GHz) the tantalum capacitor is affected by the ESL. If the ESR value is minimized at the resonance frequency, the ESL value effecting after the resonance frequency may also be reduced. In the embodiment of the present invention, the distance of electrodes can be minimized and at the same time the internal resistance can also be minimized, to reduce the ESR value at the resonance frequency and the ESL value and the ESL value effecting after the resonance frequency.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A tantalum capacitor comprising:
a plurality of tantalum sintered bodies placed side by side and formed by sintering tantalum powder;
a plurality of cathode lead lines drawn out from a first side of each of the plurality of tantalum sintered bodies in the same direction;
a molding part surrounding the plurality of tantalum sintered bodies and the plurality of cathode lead lines;
a cathode terminal provided with a first side cover unit connected to the plurality of cathode lead lines for covering the first side to be separated by the molding part and an external terminal unit for covering a portion of a top surface or a bottom surface of the plurality of tantalum sintered bodies to be separated by the molding part; and
an anode terminal provided with an opposite side cover unit for covering an opposite surface to be electrically connected to the opposite surface of the first side and an external terminal unit for covering a portion of the top surface or the bottom surface to be separated by the molding part, wherein the anode terminal is separated from the cathode terminal.

2. The tantalum capacitor according to claim 1, wherein a conductive layer is applied on the opposite surface of the plurality of tantalum sintered bodies and the anode terminal is electrically connected to the conductive layer.

3. The tantalum capacitor according to claim 1, the anode terminal is electrically connected by a conductive adhesive layer formed on the opposite surface of the plurality of tantalum sintered bodies.

4. The tantalum capacitor according to claim 1, wherein at least two of the plurality of cathode lead lines are drawn out from the first side of the same direction of each of the plurality of tantalum sintered bodies.

5. The tantalum capacitor according to claim 1, wherein a groove is formed on a protruded front end of the external terminal unit of the cathode terminal.

6. The tantalum capacitor according to claim 1, wherein a minimum space between each external terminal unit of the cathode terminal and the anode terminal is 200 to 400 μm.

7. The tantalum capacitor according to claim 1, wherein a total area of the external terminal unit of the cathode terminal and the anode terminal is 60 to 80% of the top surface or the bottom surface of the molding part.

8. A tantalum capacitor comprising:
a plurality of tantalum sintered bodies placed side by side and formed by sintering tantalum powder;
a plurality of cathode lead lines drawn out from a first side of each of the plurality of tantalum sintered bodies in the same direction;
a molding part surrounding the plurality of tantalum sintered bodies and the plurality of cathode lead lines;
a cathode terminal provided with a first side cover unit connected to the plurality of cathode lead lines for covering the first side to be separated by the molding part and an external terminal unit for covering a portion of a top surface or a bottom surface of the plurality of tantalum sintered bodies to be separated by the molding part; and
an anode terminal provided with an opposite side cover unit for covering an opposite surface of the first sides of each of the plurality of tantalum sintered bodies to be separated by the molding part, an external terminal unit for covering a portion of the top surface or the bottom surface to be separated by the molding part and an anode connecting unit to be electrically connected to a bottom surface or a top surface of the plurality of tantalum sintered bodies at the opposite sides of the external terminal unit, wherein the anode terminal is separated from the cathode terminal.

9. The tantalum capacitor according to claim 8, wherein a conductive layer is applied on the bottom surface or the top surface of the plurality of tantalum sintered bodies which is electrically connected by the anode connecting unit.

10. The tantalum capacitor according to claim 8, wherein the anode connecting unit is electrically connected by a conductive adhesive layer formed on the bottom or the top surface of the plurality of tantalum sintered bodies.

11. The tantalum capacitor according to claim 8, wherein at least two of the plurality of cathode lead lines are drawn out from the first side of the same direction of each of the plurality of tantalum sintered bodies.

12. The tantalum capacitor according to claim 8, wherein a groove is formed on a protruded front end of the external terminal unit of the cathode terminal.

13. The tantalum capacitor according to claim 8, wherein a minimum space between each external terminal unit of the cathode terminal and the anode terminal is 200 to 400 μm.

14. The tantalum capacitor according to claim 8, wherein a total area of the external terminal unit of the cathode terminal and the anode terminal is 60 to 80% of the top surface or the bottom surface of the molding part.

15. A tantalum capacitor comprising:
a plurality of tantalum sintered bodies placed side by side and formed by sintering tantalum powder;
a plurality of cathode lead lines drawn out from a first side of each of the plurality of tantalum sintered bodies in the same direction;
a molding part surrounding the plurality of tantalum sintered bodies and the plurality of cathode lead lines;
a cathode terminal provided with a first side cover unit connected to the plurality of cathode lead lines for covering the first side to be separated by the molding part and an external terminal unit for covering a portion of a top surface or a bottom surface of the plurality of tantalum sintered bodies to be separated by the molding part; and
an anode terminal provided with an opposite side cover unit for covering an opposite surface of the first sides of each of the plurality of tantalum sintered bodies to be separated by the molding part and an external terminal unit for covering a portion of the top surface or the bottom surface of the plurality of tantalum sintered bodies, wherein the external terminal unit is electrically connected to the top surface or the bottom surface of the plurality of tantalum sintered bodies and the anode terminal is separated from the cathode terminal.

16. The tantalum capacitor according to claim 15, wherein a conductive layer is applied on the top surface or the bottom surface of the plurality of tantalum sintered bodies that is electrically connected by the external terminal unit of the anode terminal.

17. The tantalum capacitor according to claim 15, wherein the external terminal unit of the anode terminal is electrically connected by a conductive adhesive layer formed on the bottom or the top surface of the plurality of tantalum sintered bodies.

18. The tantalum capacitor according to claim 15, wherein at least two of the plurality of cathode lead lines are drawn out from the first side of the same direction of each of the plurality of tantalum sintered bodies.

19. The tantalum capacitor according to claim 15, wherein a groove is formed on a protruded front end of the external terminal unit of the cathode terminal.

20. The tantalum capacitor according to claim 15, wherein a minimum space between each external terminal unit of the cathode terminal and the anode terminal is 200 to 400 μm.

21. The tantalum capacitor according to claim 15, wherein a total area of the external terminal unit of the cathode terminal and the anode terminal is 60 to 80% of the top surface or the bottom surface of the molding part.
